(19) United States
(12) Patent Application Publication
(10) Pub. No.: US 2011/0016672 A1
(43) Pub. Date: Jan. 27, 2011

(54) Clamp for medical equipment

(76) Inventor: Joseph Mancini, Philadelphia, PA (US)

Correspondence Address: Hollstein Keating Cattell Johnson & Goldstein,P.C.;Willow Ridge Executive Office Park, Suite 301, 750 Rt. 73S., Marlton, NJ, 08053, US

(21) Appl. No.: 12/460,649

(22) Filed: Jul. 22, 2009

(51) Int. Cl. F16L 33/00

(52) U.S. Cl. 24/16 R

(57) ABSTRACT

A fluid transfer hose clamp maintains the connective ends of fluid transfer hoses in the vicinity of and adjacent to the connection points of medical equipment. The clamp is an integral body having an elongated top section, two end sections extending perpendicular to the top section, and two elongated bottom sections extending parallel to the top section. Each bottom section has a distal end, the distal end of one of the bottom sections being positioned beneath the distal end of the other bottom section. The top section and bottom sections form an opening through which the fluid transfer hoses extend. A bolt and nut connection, extending through all the sections, maintains the clamp in position around the equipment's supporting bracket and the hoses to maintain the hoses in position in relation to the medical equipment to which they are to be connected.

### BACKGROUND OF THE INVENTION

This invention relates to a unique clamp for maintaining fluid transfer hoses in a relatively fixed, stationary position in relation to the medical equipment, such as serial compression machines, to which they are connected. These hoses, which primarily transfer compressed air to pressurized air boots and similar air pressurized body casts, are integral to and expensive components of this equipment. As a result, it is important that they are well maintained and always available when they are needed.

Unfortunately, during the day-to-day, busy, fast-paced and sometimes emergent conditions common to hospitals and other medical facilities, equipment is often unintentionally neglected. For example, fluid transfer hoses are routinely disconnected from serial compression or like machines in order to be moved to different patients, to be transported to different locations, or for other purposes. Disconnected hoses often then become separated and sometimes fall away from their machines. This can cause hoses to become damaged. Hoses which fall to the ground are often misplaced or lost. The hoses are not only costly to replace, but also, very importantly, they are not readily available for use when their respective machines are needed. Having to scramble to locate replacement hoses wastes time, time which a patient in need may be ill-prepared to afford.

### SUMMARY OF THE INVENTION

It is thus the object of the present invention to provide a clamp which will, at all times, maintain fluid transfer hoses in a fixed, stationary position, adjacent to medical equipment to which it is to be connected.

It is a further object of the present invention to provide a clamp which can be readily and easily secured to medical equipment and around fluid transfer hoses.

It is another object of the present invention to provide a clamp which prevents fluid transfer hoses from falling and becoming separated from medical equipment and thus misplaced or lost or damaged.

It is still another object of the present invention to provide a clamp which maintains the connective ends of fluid transfer hoses adjacent to their respective medical equipment connections, so they are available to be immediately attached and detached from the equipment.

It is a further object of the present invention to provide a clamp which, because it will prevent fluid transfer hoses from being lost or damaged, save the undue expense of hose replacement.

These and other objects are accomplished by the present invention, a unique clamp designed to maintain the connective ends of fluid transfer hoses in the vicinity of and adjacent to the connection points of medical equipment. The clamp is an integral body having an elongated top section, two end sections extending perpendicular to the top section, and two elongated bottom sections extending parallel to the top section. Each bottom section has a distal end, the distal end of one of the bottom sections being positioned beneath the distal end of the other bottom section. The top section and bottom sections form an opening through which the fluid transfer hoses extend. A bolt and nut connection, extending through all the sections, maintains the clamp in position around the equipment's supporting bracket and the hoses to maintain the hoses in position in relation to the medical equipment to which they are to be connected.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the clamp of the present invention in place around the supporting bracket of a piece of medical equipment.

FIG. 2 is a bottom isometric view of the clamp of the present invention with hoses extending therethrough.

FIG. 3 is bottom view of the clamp of the present invention with hoses extending therethrough.

FIG. 4 is a top view of the clamp of the present invention with hoses extending therethrough.

FIG. 5 is an elevation view of the clamp of the present invention with a hose extending therethrough.

FIG. 6 is the opposite elevation view of the clamp of the present invention with a hose extending therethrough.

FIG. 7 is a front view of the clamp of the present invention showing a cross-section of the hoses extending therethrough.

FIG. 8 is a rear view of the clamp of the present invention showing a cross-section of hoses extending therethrough.

FIG. 9 is an isometric view of the clamp of the present invention in place around the supporting bracket of a piece of medical equipment, with transfer hoses disconnected from the equipment.

### DETAILED DESCRIPTION OF THE INVENTION

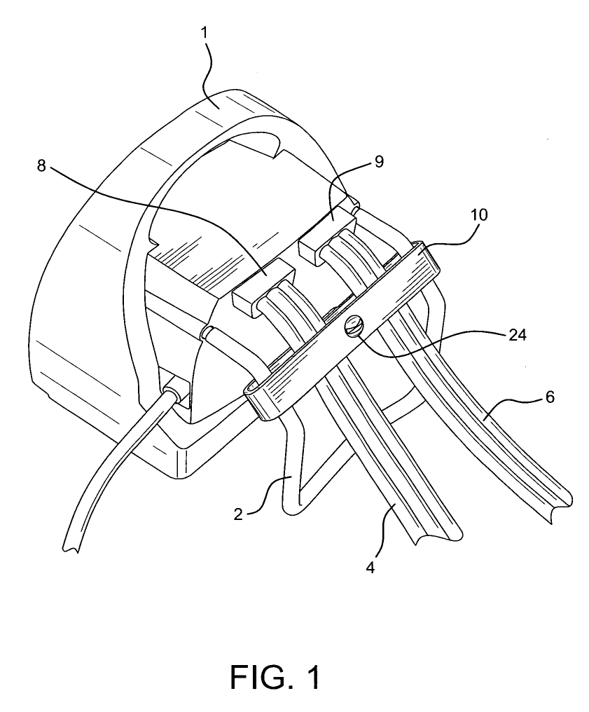

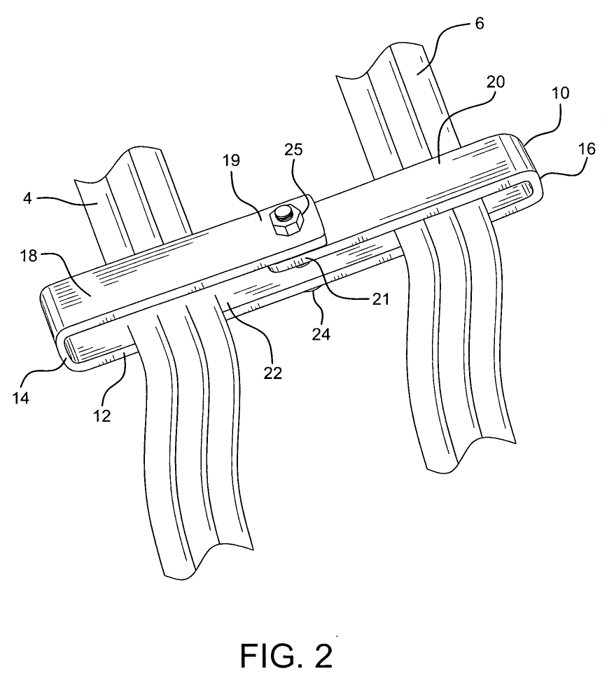

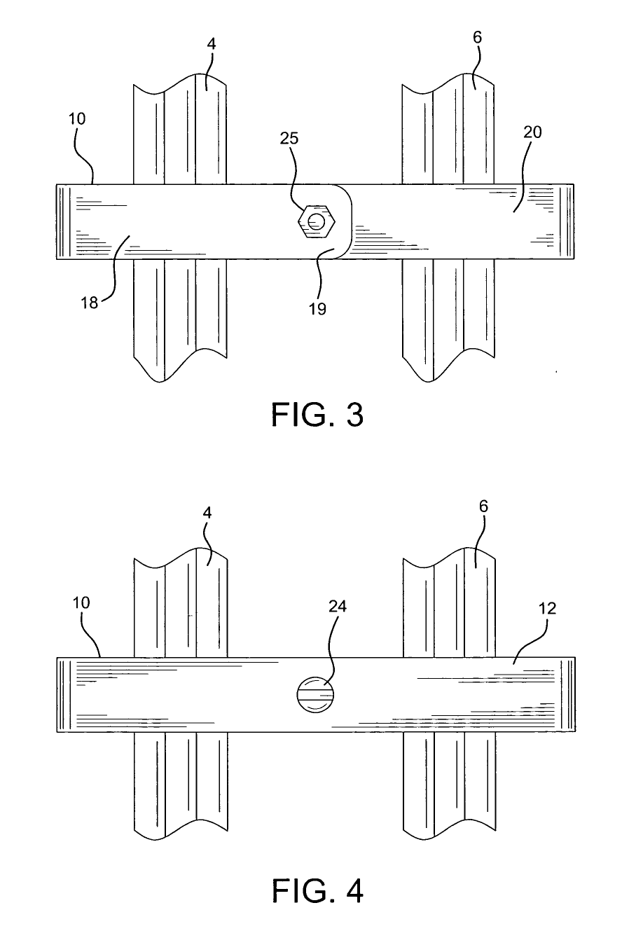

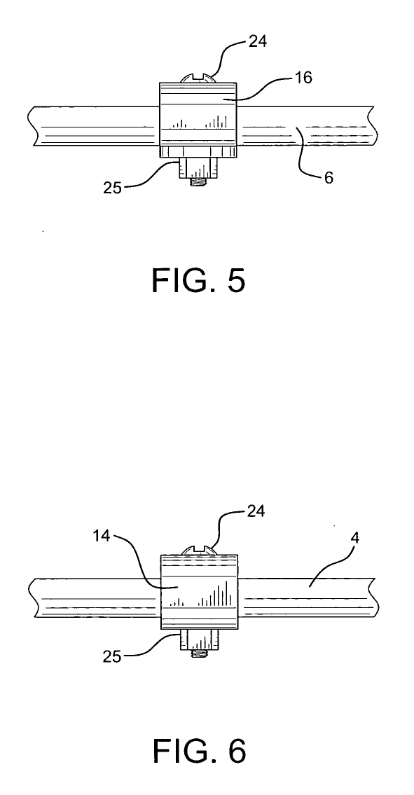

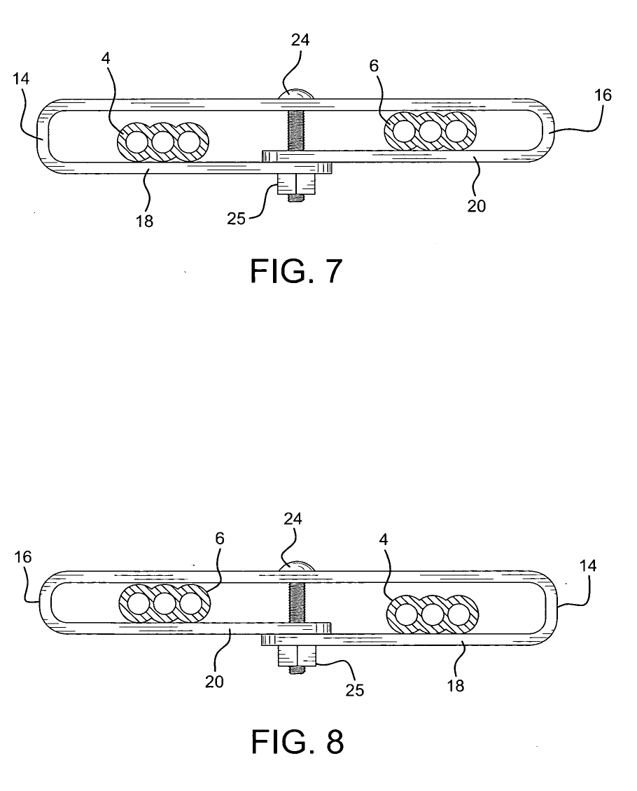

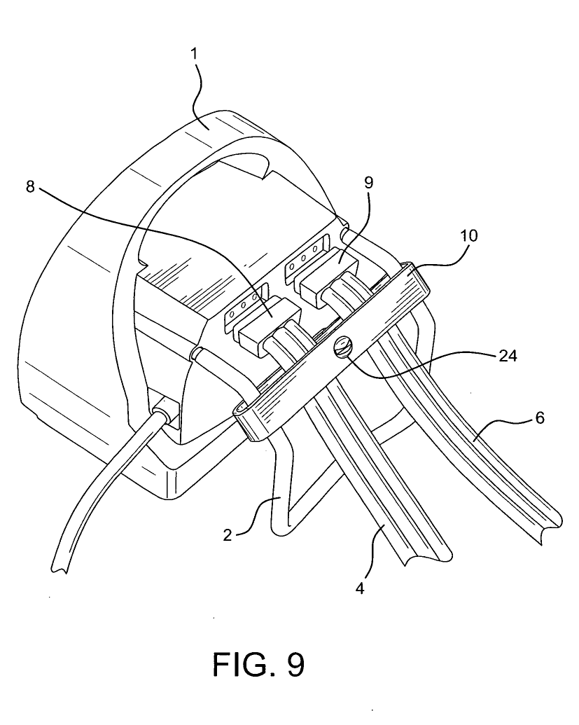

FIG. 1 shows medical equipment, here serial compression machine 1, which utilizes air pressure to compel compressed fluids, such as air. Compression machine 1 is provided for exemplar purposes only. The clamp of the present invention is not to be considered restricted to the type of equipment or hoses or fluids with which it is to be used. It is anticipated that the clamp can be used to maintain hoses which transfer liquid fluids from other medical equipment as well.

Fluid transfer hoses 4 and 6 are removeably connected to machine 1 by means of pin connectors 8 and 9. These hoses are quite expensive to replace, so it is imperative that they are not lost, misplaced, or damaged when not connected to medical equipment, such as compression machine 1. To ensure that hoses 4 and 6 remain stationary and in position, with connectors 8 and 9 at all times either connected or in position adjacent to compression machine 1, clamp 10 of the present invention is provided.

Clamp 10 is an integral body comprising an elongated top section 12 which extends substantially the full length of the clamp. End sections 14 and 16 merge smoothly down from and are substantially perpendicular to the opposing ends of clamp 10. Bottom section 18 merges smoothly and laterally from end section 14. Bottom section 18 is substantially perpendicular to end section 14 and substantially parallel to top section 12. Bottom section 20 merges smoothly and laterally from end section 16. Bottom section 20 is substantially perpendicular to end section 16 and parallel to top section 12. Opening 22 is formed between top section 12 and bottom sections 18 and 20.

Both bottom sections 18 and 20 extend to at least one half the length of clamp 10 and terminate at their distal ends 19 and 21 respectively. Distal end 19 of bottom section 18 is configured to be positioned beneath distal end 21 of top section 20. Distal ends 19 and 21 and top section 12 each have holes which are aligned to accept connection means in the form of bolt 24 and corresponding nut 25. The hole in top section 12 is located approximately at-the mid point of the top section.

In use, an appropriate support member of compression machine 1, in the example depicted in FIG. 1—rearwardly extending bracket 2, is fitted through opening 22 of clamp 10. Fluid transfer hoses 4 and 6 are likewise inserted into and pass through opening 22, such that they are completely surrounded by top section 12, end sections 14 and 16, and bottom sections 18 and 20. Bolt 24 is inserted into the aligned holes in top section 12, distal end 19 of bottom section 18, and 21 of bottom section 20, where it is then tightly secured by nut 25.

Clamp 10, thus secured around fluid transfer hoses 4 and 6, will effectively serve to maintain the hoses in place, fixed in relation to its medical equipment 1, regardless of whether their pin connectors 8 and 9 are attached to or detached from the machine. (See FIG. 9). The location of the hoses will never be an issue nor will they be subject to damage or loss.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A clamp for maintaining fluid transfer hoses in position in relation to medical machinery to which the hoses are removeably connected, the clamp having an integral body comprising:
an elongated top section extending substantially the full length of the clamp, the top section having two opposing ends;
a first end section extending from one end of the top section, said end section being substantially perpendicular to the top section;
a second end section extending from the second end of the top section, said second end section being substantially perpendicular to the top section;
a first elongated bottom section measuring at least one half the length of the clamp and extending from the first end section, the bottom section having a distal end and being substantially perpendicular to the first end section and substantially parallel to the top section;
a second elongated bottom section measuring at least one half the length of the clamp and extending from the second end section, the second bottom section having a distal end and being substantially perpendicular to the second end section and substantially parallel to the top section, said second bottom section having its distal end positioned beneath the distal end of the first bottom section; and
means extending through the top section, the first bottom section, and the second bottom section to secure the clamp around the fluid transfer hoses, whereby when the clamp is so secured, the hoses remain in a substantially fixed position in relation to the medical machinery whether or not they are connected to the medical machinery.

2. The clamp as in claim 1 wherein an opening is formed between the top section and the bottom sections through which the hoses pass.

3. The clamp as in claim 1 wherein the means to secure the clamp extends through said distal ends of the bottom sections and the approximate midpoint of the top section.

4. The clamp as in claim 1 wherein the means to secure the clamp comprises a bolt and nut connection.
